(19) United States
(12) Patent Application Publication
(10) Pub. No.: US 2014/0150017 A1
(43) Pub. Date: May 29, 2014

(54) Implicit Advertising

(71) Applicant: AT&T INTELLECTUAL PROPERTY I, L.P., Atlanta, GA (US)

(72) Inventor: Hisao M. Chang, Cedar Park, TX (US)

(73) Assignee: AT&T Intellectual Property I, L.P., Atlanta, GA (US)

(21) Appl. No.: 13/688,858

(22) Filed: Nov. 29, 2012

(51) Int. Cl. H04N 21/81

(52) U.S. Cl. CPC H04N 21/812
USPC 725/34

(57) ABSTRACT

A method includes, during presentation of media content at a display device, receiving, at a computing device a time value corresponding to the presentation of the media content and identification information corresponding to the presentation of the media content. The method further includes sending, from the computing device, a request for advertising information to a remote computing device. The request includes the time value and the identification information. The method further includes, in response to the request, receiving advertising source information indicating one or more advertising sources of the advertising information. The one or more advertising sources are selected based at least in part on the time value and the identification information.

### FIELD OF THE DISCLOSURE

The present disclosure is generally related to targeted advertisement in media content.

### BACKGROUND

A targeted advertising system may strategically place product advertisements or other advertising content within media content to attract user attention during playback of the media content. To implement such systems, prior arrangements may be made for advertisers to place advertisements in particular scenes during filming of the media content. However, targeted advertising may increase a cost to produce the media content because of accommodations, such as equipment and props (e.g., large billboards), that may be used to film the media content with advertising content. Replacement or removal of the advertising content included in previously filmed media content may be difficult and may use significant processing capacity.

### BRIEF DESCRIPTION OF THE DRAWINGS

FIG. 1 is a diagram illustrating an embodiment of a system to provide implicit advertising associated with a presentation of media content;

FIG. 2 is a flowchart diagram illustrating a first embodiment of a method to provide implicit advertising associated with a presentation of media content;

FIG. 3 is a flowchart diagram illustrating a second embodiment of a method to provide implicit advertising associated with a presentation of media content;

FIG. 4 is an illustration of an illustrative embodiment of a general computer system.

### DETAILED DESCRIPTION

Implicit advertising enables unobtrusive, visual objects (e.g., a star, an alert, or an image) to be displayed or overlaid during a presentation of media content (e.g., a video, video-on-demand content, a movie, a television program, a live event, or a recorded program) to indicate that advertising information related to particular objects (e.g., a physical object, such as an article of clothing, a structure, food, a location, etc.) in the presentation is available. An advertising system may direct the viewer to the advertising information by sending network addresses or other communication information identifying sources of information to a computing device accessible to the viewer.

The sources of information may provide access to the advertising information. The computing device may receive the network addresses or the other communication information in response to the viewer expressing interest, via the computing device, for particular objects seen during the presentation of the media content, where the particular objects are associated with implicit advertisements. The sources of information may include or may be indicated by one or more uniform resource locator (URL) addresses identifying websites that provide the advertising information, one or more advertising channels that can be automatically presented at a media device to provide the advertising information, or access to one or more call centers that can provide the advertising information (e.g., product information), facilitate transactions to receive products associated with the advertising information, or both. The sources of information may be stored at a memory of the computing device to enable the viewer to retrieve the sources of information at a later time (e.g., after a presentation of the media content). At the later time, the computing device may present one or more selectable identifiers (e.g., bookmarks) that enable the viewer to access one or more of the sources of information available during a previous presentation of the media content.

A third party (e.g., an advertiser, a product retailer, or a product manufacturer) may specify, to a media distribution system, the sources of information to be associated with implicit advertisements for particular objects that appear in a presentation of media content. For example, the third party may store the advertising information at a storage location (e.g., an advertisement library) and may send information identifying the storage location to the media distribution system. The information may identify the sources of information that provide access to the advertising information to be associated with an implicit advertisement for an object that appears in the presentation of the media content. The third party may purchase implicit advertising placement from a media distributor to associate the advertising information with a particular object or a particular type of object that may appear in the presentation of the media content.

In a particular embodiment, information identifying the sources of information may be specified via an electronic program guide (EPG) entry associated with media content. A media distribution system associated with the media distributor may facilitate presentation of implicit advertisements associated with the sources of information based on implicit advertising placement purchased by the third party.

During the presentation of the media content, a viewer can express interest in a particular object associated with an implicit advertisement that is identifiable during a presentation of the media content during a particular time period (e.g., a frame associated with a particular playback time of the presentation). For example, the viewer can use a computing device to send a message indicating the viewer's interest to the media distribution system. The message may include information identifying the media content and identifying the particular time period. The media distribution system may access EPG data to locate an EPG entry associated with the media content based on the message. The media distribution system may communicate, to the computing device associated with the viewer, information identifying (e.g., network addresses or other communication information) the sources of information, such as advertising information sources that correspond to implicit advertisements presented during the particular time period when the viewer expressed interest. The media distribution system may obtain the information identifying the sources of information based on information contained in the EPG entry associated with the media content, by communication with a source identified in the EPG entry associated with the media content, or both.

Thus, a viewer interested in a particular object during the presentation of the media content may obtain useful information about the particular object and may engage in a transaction to obtain a product associated with the particular object. Additionally, implicit advertising may enable the viewer to view advertising information without interrupting the presentation of the media content. The viewer may choose to continue viewing the media content uninterrupted when an implicit advertisement is seen and may instead view advertising information from the one or more sources of information associated with the implicit advertising at a later time.

In a particular embodiment, a method includes, during presentation of media content at a display device, receiving, at a computing device, a time value corresponding to the presentation of the media content and identification information corresponding to the presentation of the media content. The method further includes sending, from the computing device, a request for advertising information to a remote computing device. The request includes the time value and the identification information. The method further includes, in response to the request, receiving advertising source information indicating one or more advertising sources of the advertising information. The one or more advertising sources are selected based at least in part on the time value and the identification information.

In another particular embodiment, a computing device includes a processor and a memory accessible to the processor. The memory includes instructions that, when executed by the processor, cause the processor to perform operations including, during presentation of media content at a display device, receiving, at the computing device, a time value corresponding to the presentation of the media content and identification information corresponding to the presentation of the media content. The operations further include sending, from the computing device, a request for advertising information to a remote computing device. The request includes the time value and the identification information. The operations further include, in response to the request, receiving advertising source information indicating one or more advertising sources of the advertising information. The one or more advertising sources are selected based at least in part on the time value and the identification information.

In another particular embodiment, a computer-readable storage device includes instructions that, when executed by a processor, cause the processor to perform operations including, during presentation of media content at a display device, receiving, at a computing device, a time value corresponding to the presentation of the media content and identification information corresponding to the presentation of the media content. The operations include sending, from the computing device, a request for advertising information to a remote computing device. The request includes the time value and the identification information. The operations further include, in response to the request, receiving advertising source information indicating one or more advertising sources of the advertising information. The one or more advertising sources are selected based at least in part on the time value and the identification information.

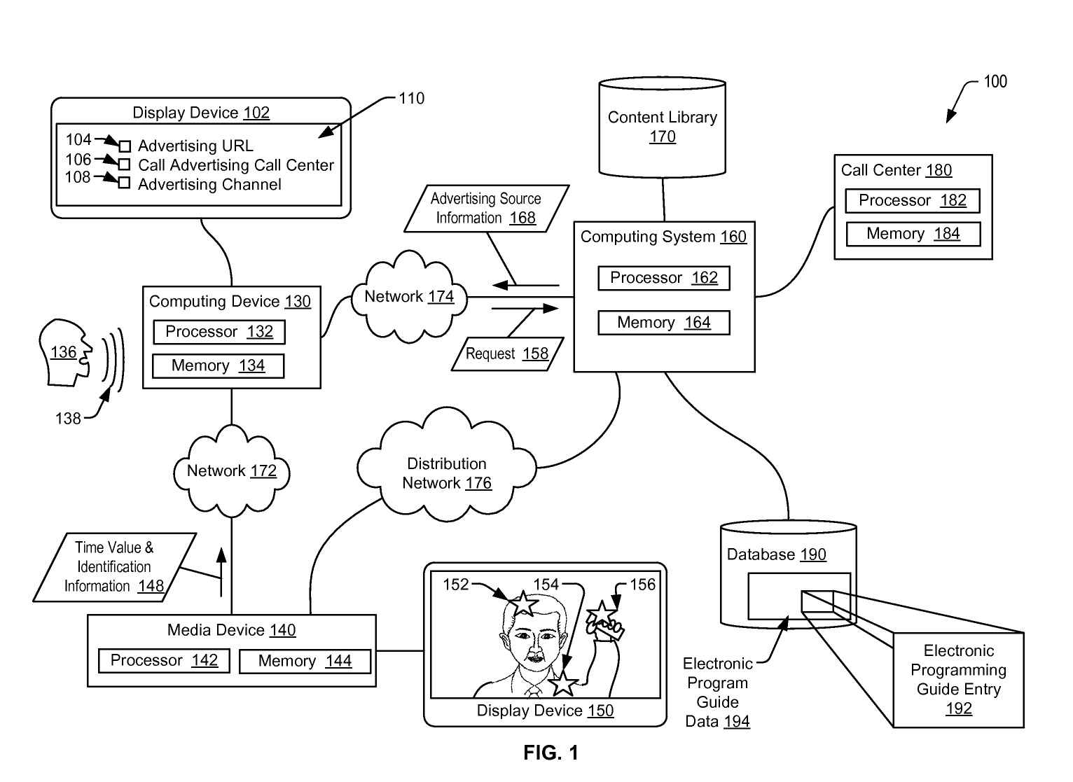

Referring to FIG. 1, a diagram illustrating a system 100 to provide implicit advertising associated with a presentation of media content is shown. The system 100 enables a user, such as the user 136, to access information (e.g., advertising information and content) that is associated with particular portions of media content during a presentation of the media content. The system 100 enables advertisements to be associated with particular portions of media content after the media content has been produced.

The system 100 may include a content library 170, a database 190, a computing system 160, and a call center 180. The system 100 may include one or more computing devices, such as the computing device 130. The computing device 130 may include or may be coupled to a display device 102. The system 100 may include one or more media devices, such as a media device 140. The media device 140 may include or may be coupled to a display device 150. The computing device 130, media device 140, or both, may be associated with a user, such as the user 136.

The computing system 160 may be adapted to facilitate distribution of media content via a distribution network 176 to one or more media devices including the media device 140. For example, the computing system 160 may be associated with or may be a component of a media distribution system. The distribution network 176 may include or may be associated with a cable television distribution network, broadcast television distribution network, an internet protocol television (IPTV) network, a content distribution network, a media distribution network, or a combination thereof. The computing system 160 may be operable to communicate with one or more computing devices, such as the computing device 130, via a network 174. The network 174 may include or may be associated with a public network, a private network, a mobile communication network, a wireless access network, a local area network, or a combination thereof.

The computing system 160 may include one or more computing devices, such as one or more servers. The one or more computing devices, may be remotely located from the computing device 130. For example, the computing system 160 may include one or more content servers, one or more video-on-demand servers, one or more electronic program guide (EPG) servers, other servers that provide advertisement information or that facilitate communication between devices (e.g., the computing device 130 and the media device 140) associated with the user 136, devices associated with one or more third parties, other servers containing media content, or a combination thereof. The computing system 160 may include one or more processors, such as a processor 162 and a memory storage device, such as a memory 164. The memory 164 may include instructions executable by the processor 162 to perform one or more operations described herein as being performed by the computing system 160.

The content library 170 may store one or more media content items, information identifying one or more media content items, or both. The media content items may include movies, television programming, sporting events, video-on-demand content, other pre-produced content, recorded media content, or a combination thereof. The content library 170 may be accessible to the computing system 160. For example, the computing system 160 may send one or more media content items of the content library 170 to the media device 140 via the distribution network 176.

In a particular embodiment, the computing system 160 may be configured to insert one or more implicit advertisement markers in one or more media content items provided to the media device 140. An implicit advertisement marker may indicate that additional information (e.g., advertisement information) related to a particular object (referred to herein as a “video object”) that appears in a presentation of the particular media content item is available. A video object may be identifiable by a keyword associated with a video lexicon. The computing system 160 may create or access a video lexicon that identifies a set of video objects associated with a particular media content item. The implicit advertisement marker may be unobtrusive (e.g., flashing or a particular shape, such as a star). The video object may correspond to a physical object depicted with the media content item, such as an article of clothing (e.g., a hat, a scarf, a watch, or a pair of shoes), a physical structure (e.g., a house), or an electronic appliance (e.g., a refrigerator). Location information may be associated with the video object, providing an indication of one or more locations (e.g., an x-axis display coordinate and a y-axis display coordinate) in the presentation of the particular media content item. The implicit advertisement marker may be positioned based on the location information, such as being overlaid in the presentation of the particular media content item. The one or more implicit advertisement markers may be provided to the media device before, during, or after distribution of the particular media content item and before a presentation of the media content item.

Implicit advertising may be specified by a third party (e.g., an advertiser, a product retailer, a product manufacturer, or a combination thereof) for a media content item. For example, the third party may purchase implicit advertising placement from a media distributor associated with the computing system 160 to associate advertising information with one or more video objects. The third party may specify that the implicit advertising placement is to be provided for a particular portion (e.g., a particular percentage) of times that one or more video objects appear in the presentation of the media content.

The database 190 may include electronic program guide (EPG) data 194. The EPG data 194 may include one or more EPG entries, such as an EPG entry 192, containing information descriptive of one or more media content items that may be provided to users (e.g., the user 136) via the distribution network 176. For example, the EPG data 194 may include information describing scheduled programming to be broadcast, transmitted, or distributed via the distribution network 176 to the users (e.g., the user 136) associated with the distribution network 176, such as subscribers associated with a service provided by the distribution network 176. In another example, the EPG data 194 may include information describing video-on-demand content to be distributed via the distribution network 176 to users associated with the distribution network. The contents of the database 190 may be created, managed, updated, or a combination thereof, by a computing system (not shown) associated with an EPG data provider, a media distribution system associated with a media distributor (e.g., the computing system 160), or both.

In a particular embodiment, one or more EPG entries (e.g., the EPG entry 192) of the EPG data 194 indicate or identify one or more sources of information (e.g., advertising information) related to a particular media content item. For example, the particular EPG entry 192 may include one or more advertising uniform resource locator (URL) addresses that provide an address to a location (e.g., a website) where advertising information related to a particular media content item may be obtained. The advertising information may include product information, retailer information, manufacturer information, or a combination thereof, for one or more products being advertised. The one or more sources of information may be located at an address associated with one or more servers. The one or more servers may be associated with a third party (e.g., an advertiser, a product retailer, or a product manufacturer) that provide advertising information, facilitates transactions related to one or more products being advertised, or both. Alternatively, the one or more servers may be associated with a website (e.g., a provisioning website) that manages one or more product endorsements (e.g. advertisements) associated with one or more media content items. The one or more sources of information may be associated with a particular geographic location (e.g., a zip code, region of a country, a country, a city, etc.). For example, in the particular EPG entry 192, a first URL address for a first source of advertising information may be associated with a first geographic location, and a second URL address for a second source of advertising information may be associated with a second geographic location.

A particular EPG entry 192 may correspond to a particular media content item and may include a time value associated with one or more sources of information. The time value may correspond to a time period (e.g., a frame, a timestamp, or a playback time) corresponding to a presentation of the particular media content item when the one or more sources of information are associated with implicit advertising. For example, the particular EPG entry 192 may include an advertising URL addresses associated with a particular frame number of the particular media content item. During a presentation of the particular media content item, an implicit advertising marker may be presented during the presentation of a frame of the particular media content item corresponding to the particular frame number.

In a particular embodiment, information identifying the one or more sources of information may be updated in the EPG data 194 by a third party (e.g., an advertiser, a product manufacturer, a product retailer, a third party associated with the advertiser, or a combination thereof). For example, the information identifying the one or more sources of information in the EPG data 194 may be updated via a website (e.g., a provisioning website). The information identifying the one or more sources of information may be updated periodically or at any time after production of media content. One or more keywords may be associated with the information identifying the one or more sources of information in a particular EPG entry 192. The keywords may be used to specify implicit advertising for a particular media content item associated with the particular EPG entry 192. The keywords may be used to identify one or more video objects associated with the particular media content item to be associated with implicit advertisements. For example, an implicit advertisement marker may be designated for a video object identified by a video lexicon that matches the one or more keywords associated with the one or more sources of information.

The computing device 130 may be a mobile phone, a personal computer, a terminal, a server, tablet computing device, a laptop computer, a mobile device, or a combination thereof. The mobile device may be, but is not limited to, a smart phone, a personal digital assistant, and/or a mobile personal computer. The computing device 130 may include one or more processors, such as a processor 132 and a memory storage device, such as a memory 134. The memory 134 may include instructions executable by the processor 132 to perform one or more operations described herein as being performed by the computing device 130.

The computing device 130 may be in communication with one or more devices, such as the media device 140. For example, the computing device 130 may communicate with the media device 140 via a network 172. The network 172 may include one or more networks that facilitate communication between the computing device 130 and media device 140, such as one or more local area networks. The network 172 may be associated with a public network, a private network, a mobile communication network, a wireless access network, a local area network, or a combination thereof. The computing device 130 may be operable to receive information related to a particular media content item presented at the display device 150 by the media device 140. For example, the computing device 130 may be configured to execute an application that receives data from the media device 140 related to a presentation of a particular media content item at the display device 150. The data may include synchronization information identifying a presentation of the particular media content item. The synchronization information may include a timestamp or playback time associated with a frame or a scene of the particular media content item, a title associated with the particular media content item, a channel identifier associated with the presentation of the particular media content item, other information that identifies the presentation of the particular media content item, or a combination thereof.

In a particular embodiment, the computing device 130 facilitates access to additional information (e.g., advertising information) related to the presentation of media content at the display device 150. The computing device 130 may be configured to receive input indicating a request for the additional information (e.g., advertising information) associated with a presentation of the media content item at the display device 150. To illustrate, the computing device 130 may be configured to execute an application that receives input from the user 136 to request the additional information associated with the media content item presented at the display device 150. The voice data 138 received from the user 136 may include the request for the additional information associated with the media content item. Alternatively, or in addition, input data corresponding to the request for the additional information may be received via the display device 102, another input device (not shown) coupled to or included in the computing device 130, or both. The received input may indicate that the user 136 desires to access the additional information related to an implicit advertisement marker seen during the presentation of the media content item at the display device 150.

The computing device 130 may communicate, to the computing system 160 via a network 174, a request related to the input indicating the request for the additional information. The network 174 may include one or more networks that facilitate communication between the computing device 130 and computing system 160. The network 174 may be associated with an application service provider, a network access service provider (e.g., a mobile communication network provider, an internet or intranet access service provider, or both). The computing device 130 may be operable to receive advertising source information 168 indicating one or more sources of information from the computing system 160 via the network 174.

In a particular embodiment, the computing device 130 stores the advertising source information 168 in the memory 134 to enable the computing device 130 to retrieve the advertising source information 168 associated with the media content item at a later time (e.g., after the presentation of the media content item). The advertising source information 168 may be stored with the time value and the identification information 148, the synchronization information received from the media device 140, other information that identifies a presentation of a particular media content item, or a combination thereof, to enable location of the advertising source information 168 for one or more media content items previously presented.

The media device 140 may be, but is not limited to, a set-top box (STB) device, a digital video recorder device, a personal video recorder device, a computing device capable of receiving one or more media content items from the computing system 160 via the distribution network 176, or a combination thereof. The media device 140 may include one or more processors, such as a processor 142 and a memory storage device, such as a memory 144. The memory 144 may include instructions executable by the processor 142 to perform one or more operations described herein as being performed by the media device 140. The media device 140 may be configured to receive one or more media content items from the computing system 160 and to cause the display device 150 to present the one or more media content items.

The media device 140 may be in communication with one or more computing devices, such as the computing device 130. In a particular embodiment, the media device 140 may be configured to communicate, to the computing device 130, synchronization information (e.g., a time value and an identification information 148) corresponding to a presentation of a media content item at the display device 150. The synchronization information may be sent in response to receiving information from the computing device 130 indicating that the user 136 has requested additional information (e.g., advertising information) associated with the presentation of the media content item at the display device 150.

In a particular embodiment, the media device 140 may be configured to identify one or more implicit advertisement markers corresponding to or embedded within one or more media content items received from the computing system 160 via the distribution network 176. The implicit advertisement markers may be used by the media device 140 to generate representations (e.g., a graphic overlay, such as a flashing image) to be presented at particular portions within the presentation of the media content item at the display device 150 during a particular time. An implicit advertisement marker may include information indicating the particular time and a location to display the implicit advertisement marker during the presentation of the media content item. The representations may provide an indication to a viewer, such as the user 136, that advertisement information associated with the particular portions of the presentation is available. The implicit advertisement markers may be received as data via a separate data stream (e.g., a data channel or a data stream of distinct data packets), data embedded within a media stream that provides a media content item, or both. Alternatively, data to generate the implicit advertisement markers may be stored in the memory 144 of the media device 140. Trigger information indicating when and where to display the representations based on the data (to generate the implicit advertisement markers) may be received at the media device 140 from the computing system 160 (e.g., via the separate data stream or via the media stream).

The call center 180 may be configured to provide additional information associated with an implicit advertisement. A third party, such as an advertiser, a product manufacturer, a product retailer, another party associated with the advertiser, or a combination thereof, may be associated with the call center 180 or may facilitate operation of the call center 180. The call center 180 may include one or more processors, such as a processor 182, and a memory storage device, such as a memory 184. The memory 184 may include instructions executable by the processor 182 to perform one or more operations described herein as being performed by the call center 180. The additional information may include product information, retailer information, manufacturer information, or a combination thereof, for one or more products being advertised via an implicit advertisement. The call center 180 may also, or in the alternative, facilitate transactions related to one or more products being advertised.

In operation, the media device 140 may receive a particular media content item from the computing system 160. The particular media content item may be stored in the memory 144 of the media device 140 for retrieval and playback at the display device 150 during a later time or may be sent to the display device 150 for display. During presentation of the particular media content item, the media device 140 may generate one or more representations associated with each of the one or more implicit advertisement markers. The one or more representations may be displayed in the presentation of the particular media content item at a particular time. The particular time may be determined based on information associated with a particular implicit advertisement marker. In the presentation of the particular media content item, a representation of a particular implicit advertisement marker may be displayed as an overlay at a location determined based on information in or associated with the particular implicit advertisement marker. For example, in FIG. 1, representations associated with particular implicit advertisement markers are illustrated as stars, such as a first star representing a first implicit advertisement marker 152, a second star representing a second implicit advertisement marker 154, and a third star representing a third implicit advertisement marker 156. Each star that represents one of the implicit advertisement markers 152-156 is overlaid in the presentation of a particular media content item displayed in the display device 150. Each of the implicit advertisement markers 152-156 may indicate to the user 136 that additional information (e.g., advertising information) is associated with the presentation of the particular media content item or with particular portion of the presentation of the particular media content item. For example, the second implicit advertisement marker 154 may indicate availability of additional information associated with a jacket worn by a presenter in the presentation of the particular media content item.

During presentation of the particular media content item, the media device 140 may provide synchronization information associated with the presentation of the particular media content item to one or more computing devices, such as the computing device 130. In one example, the media device 140 may provide the synchronization information in response to the computing device 130 executing an application that requests or retrieves the synchronization information from the media device 140. The synchronization information may include the time value and the identification information 148 corresponding to the presentation of the particular media content item at the display device 150. In a particular embodiment, the identification information may include a title associated with the particular media content item, a channel identifier associated with the particular media content item, other information that identifies the presentation of the particular media content item, or a combination thereof. The time value may include a synchronization time, such as a time stamp or a playback time corresponding to a frame or a scene associated with the presentation of the particular media content item.

The media device 140 may provide synchronization information to the computing device 130 periodically, occasionally, or in response to a request from the computing device 130. When the media device 140 provides the synchronization information periodically, the period may depend on whether one or more implicit advertisement markers are represented in the presentation of the particular media content item. That is, the synchronization information may be provided to the computing device 130 more frequently in response to an increase in frequency at which implicit advertisement markers are displayed in the presentation and less frequently in response to a decrease in frequency at which implicit advertisement markers are displayed in the presentation. In a particular embodiment, the media device 140 may provide the time value and the identification information 148 to the computing device 130 when one or more representations of implicit advertisement markers, such as the implicit advertisement markers 152-156, are displayed.

The computing device 130 may present information associated with one or more representations of implicit advertisement markers (e.g., the implicit advertisement markers 152-156). For example, the computing device 130 may cause the display device 102 to present one or more sources of advertising information related to one or more implicit advertisement markers that appeared during the presentation of the particular media content item associated with the time value and the identification information 148. To illustrate, in FIG. 1, the computing device 130 may cause the display device 102 to present a graphical user interface 110 that includes one or more selectable controls configured to access one or more sources of advertising information. The one or more selectable controls may include a first selectable control 104, a second selectable control 106, and a third selectable control 108.

The first selectable control 104 may be associated with an advertising URL address that provides access to advertising information at a location specified by the advertising URL address. Selection of the first selectable control 104 may cause the computing device 130 to display advertising information, obtained from a source accessible at the advertising URL address, at the display device 102. For example, the computing device 130 may cause the display device 102 to present a page of a website obtained from the source at the advertising URL address. The website may provide the advertising information corresponding to a video object corresponding to one or more of the implicit advertisement markers 152-156 appearing in the presentation of the particular media content item,

The second selectable control 106 may be associated with an advertising call center that may be able to provide advertising information. Selection of the second selectable control 106 may cause the computing device 130 to initiate a call to an advertising call center, such as the call center 180. The call may be initiated via the computing system 160. In a particular embodiment, the call may be a voice-over-internet protocol (Voice-over-IP) call, which may be connected via a particular application executing on the computing device 130. The computing system 160 may provide the call center 180 with information about the computing device 130, information about the user 136, information about the second selectable control 106, information about the particular media content item presented at the display device 150, other information that enables the call center 180 to provide advertising information or to facilitate a transaction, or a combination thereof.

Through the call center 180, the user 136 may be able to obtain advertising information, engage in transactions related to one or more products, or both, associated with an implicit advertisement (e.g., the implicit advertisement markers 152-156) that appears in the presentation of the particular media content item, or both. For example, the call center 180 may include, may implement, or may have access to an automated (or interactive) voice response system that is adapted to interact with the user 136 to provide advertising information, or to perform transactions related to the advertising information. The call center 180 may include one or more agent stations associated with call center agents (e.g., customer service agents) that may communicate with the user 136 via the computing device 130. The user 136 may be able to communicate directly with the call center agents to obtain advertising information, to perform transactions related to the advertising information, or both.

One or more of the selectable controls, such as the third selectable control 108, may be associated with an advertising channel that may provide advertising information related to one or more of the implicit advertisement markers represented in the presentation of the particular media content item. Selection of the third selectable control 108 may cause the computing device 130 to access an advertising channel that provides the advertising information. Alternately, selection of the third selectable control 108 may cause the computing device 130 to direct the media device 140 to display advertising content at the display device 150, where the advertising content is received from the advertising channel associated with the advertising information. The advertising channel may be presented in a picture-in-picture (PIP) window in the presentation of the particular media content item at the display device 150. Accordingly, by selecting one or more user selectable controls at the display device 102 of the computing device 130, the user 136 may be provided with advertising content implicitly indicated in the presentation of the media content at the display device 150.

In a particular embodiment, information to access the one or more sources of advertising information (e.g., the sources of advertising information associated with the selectable controls 104-108) may be obtained in response to a request received at the computing device 130 from the user 136. The one or more sources of advertising information may be associated with a time period when the request is received at the computing device 130. In response to receiving the request from the user 136, the computing device 130 may send the request 158 to the computing system 160 for the one or more sources of advertising information. The request 158 may include information related to the one or more implicit advertisement markers 152-156 in the presentation of the particular media content item. For example, the request 158 may include the time value and the identification information 148 most recently received at the computing device 130 before the request was received from the user 136. The time value and the identification information 148 may enable the computing system 160 to identify a particular frame of the particular media content item that was presented at the display device 150 during a time corresponding to receipt of the request from the user 136.

In a particular embodiment, the computing device 130 may include additional request criteria in the request 158. The additional request criteria may be provided by the user 136 to identify the one or more sources of advertising information. For example, the computing device 130 may cause the display device 102 to present a display (not shown) that enables the user 136 to provide input specifying the additional request criteria. In another example, the computing device 130 may receive the voice data 138 specifying the additional request criteria.

The additional request criteria may enable the computing system 160 to distinguish between advertising information associated with more than one of the implicit advertisement markers 152-156 represented in the presentation of the particular media content item. The additional search criteria may include one or more search queries related to the presentation of the media content. To illustrate, the voice data 138 may indicate a search query such as “please give more information about those shoes.” In a particular embodiment, the additional request criteria includes information to specify a particular implicit advertisement marker. For example, the voice data 138 may indicate that user 136 is interested in information about the implicit advertising marker 154 rather than the implicit advertisement marker 152 or the implicit advertisement marker 156. The voice data 138 may specify a product, a type of product, a brand, a category of products, other product related information, or a combination thereof, associated within a particular implicit advertisement marker. In a particular embodiment, the additional request criteria may enable the computing system 160 to identify sources of advertising information for a particular product brand. For example, the voice data 138 may be used to distinguish between two or more similar types of products that are associated with implicit advertisement marker in a presentation at the display device 150.

The computing system 160 may determine the one or more sources of advertising information based on information indicated in the request 158. In a particular embodiment, the one or more sources of advertising information may be determined using information in the EPG data 194. For example, the computing system 160 may locate a particular EPG entry 192 in the EPG data 194 based on the particular media content item identified by the request 158. Information identifying the one or more sources of advertising information for the particular media content item may be determined based on the particular EPG entry 192. For example, the particular EPG entry 192 may indicate one or more advertising URL addresses that provide an address to a location where advertising information may be obtained.

In a particular embodiment, the computing system 160 may send a request (not shown) to one or more servers associated with a third party (e.g., an advertiser, a product manufacturer, or a product retailer) to obtain information identifying the one or more sources of advertising information. In the request to the third party, the computing system 160 may include identification information corresponding to the particular media content media content item that was presented at the display device 150 when the request 158 was generated. The request may include a particular time value corresponding to a particular frame of the particular media content item that was presented at the display device 150 when the request 158 was generated. The one or more servers associated with the third party may use the time value and the identification information to determine the one or more sources of advertising information. The one or more sources of advertising information may correspond to the one or more of the implicit advertisement markers 152-156 that were presented at a time period corresponding to the time value.

In a particular embodiment, the computing system 160 may process the voice input data 138 included in the request 158 to identify one or more search terms. The one or more search terms may be provided in the request to the one or more servers associated with the third party to be used to further identity the one or more sources of advertising information.

The computing system 160 may send advertising source information 168 to the computing device 130 in response to determining the one or more sources of advertising information. The advertising source information 168 may identify the one or more sources of advertising information. The one or more sources of advertising information may identify one or more servers, other computing devices, call centers (e.g., the call center 180), or a combination thereof where advertising information can be accessed. The advertising source information 168 may include computer network addresses or other communication information (e.g., addresses or telephone numbers), associated with the one or more sources of advertising information. For example, the advertising source information 168 may include a network address associated with the call center 180, which may enable the user 136 to access the call center 180 via the computing device 130. The graphical user interface 110 may be generated based on the advertising source information 168. For example, each of the one or more sources of advertising information corresponding to one of the selectable controls 104-108 may correspond to a distinct portion of information in the advertising source information 168 identifying one of the sources of advertising information.

The computing device 130 may cause the display device 102 to present one or more selectable identifiers (not shown) (e.g., bookmarks, hyperlinks, icons, etc.) that enable access to one or more sources of advertising information (e.g., one or more servers, other computing devices, call centers, computer network addresses, other communication information, or a combination thereof, where advertising information can be accessed) associated with a previous presentation of one or more media content items at the display device 150. A particular selectable identifier of the one or more selectable identifiers may be displayed with one or more keywords (e.g., keywords associated with video objects), one or more images (e.g., product logos), or both, associated with one or more sources of advertising information accessible via the particular selectable identifier. The one or more sources of advertising information may correspond to a distinct portion of the advertising source information 168 received for a previous presentation of each of the one or more media content items. The advertising source information 168 for may be retrieved from the memory 134 of the computing device 130. Input (e.g., one or more titles of previously presented media content items) from a user may be received at the computing device 130 to retrieve the advertising source information 168 from the memory 134.

Thus, the system 100 enables advertising information to be associated with media content after production of the media content. The media content that has already been produced can be presented at a display device without alteration and may be associated with advertising information corresponding to implicit advertising markers presented with the media content. The implicit advertising markers may be presented during particular time periods in the presentation of the media content, such that particular advertising information (such as advertising source information associated with advertising sources) can be provided corresponding to the particular time periods. A viewer may be able to request the particular advertising information during the particular time period. The system 100 may also provide statistical information, such as viewer interest, related to presentation of the media content and associated advertising information. Such statistical information may be useful to media distributors in scheduling distribution of media content based on viewer interest. The statistical information may enable an advertiser to better ascertain interest in particular products tied to implicit advertisements. Further, the advertising content can be associated with particular portions of the media content, such as frames, segments, or video objects rather than or in addition to an entirety of the media content. Thus, implicit advertising enables targeted advertising to be provided for specific subsections or portions of the media content, rather than the entirety of the media content.

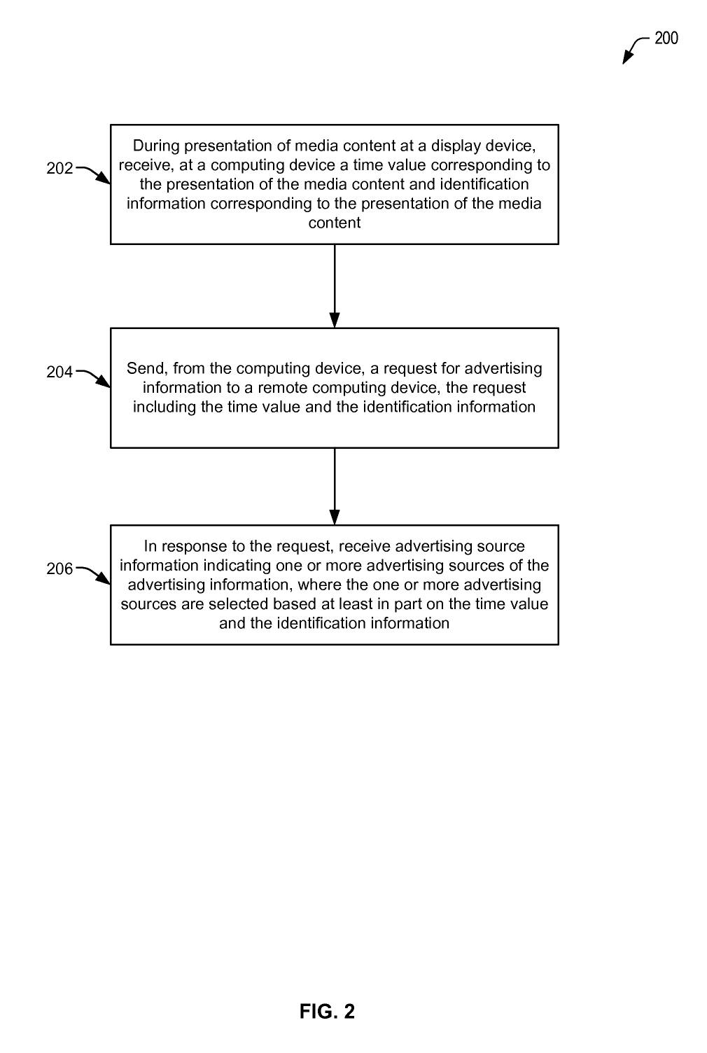

Referring to FIG. 2, a flowchart diagram illustrating a first embodiment of a method 200 to provide implicit advertising associated with presentation of media content is shown. In a particular embodiment, the method 200 may be performed by the computing device 130 of FIG. 1.

At 202, the method 200 includes, during presentation of media content at a display device, receiving, at a computing device, a time value corresponding to the presentation of the media content and identification information corresponding to the presentation of the media content. For example, during presentation of media content at the display device 150 of FIG. 1, the computing device 130 may receive the time value and identification information 148 corresponding to the presentation of media content from the media device 140.

At 204, the method 200 includes sending, from the computing device, a request for advertising information to a remote computing device. The request may include the time value and the identification information. For example, the computing device 130 of FIG. 1 may send the request 158 for advertising information to the computing system 160. The request 158 may include the time value and the identification information 148.

At 206, the method 200 includes, in response to the request, receiving advertising source information indicating one or more advertising sources of the advertising information. For example, in response to the request 158, the computing device 130 of FIG. 1 may receive the advertising source information 168 indicating one or more advertising sources of the advertising information. The one or more advertising sources may be selected based at least in part on the time value and the identification information. For example, the one or more advertising sources may be selected by the computing system 160 based on the one or more of the implicit advertisement markers 152-156 that appeared during a presentation of a media content item associated with the identification information at a time period corresponding to the time value.

Receiving advertising source information identifying one or more advertising sources related to presentation of media content may reduce an amount of distraction otherwise caused to a viewer relative to advertising placed within presented of media content. For example, the viewer can access advertisements related to products presented in media content at a later time that is convenient to the viewer. Providing advertising information via one or more advertising sources instead of within a presentation of media content, enables third parties (e.g., advertisers) to remove or change targeted advertisements without incurring significant production cost. Thus, advertisers may not be limited to targeted advertising of products that are available during production of media content.

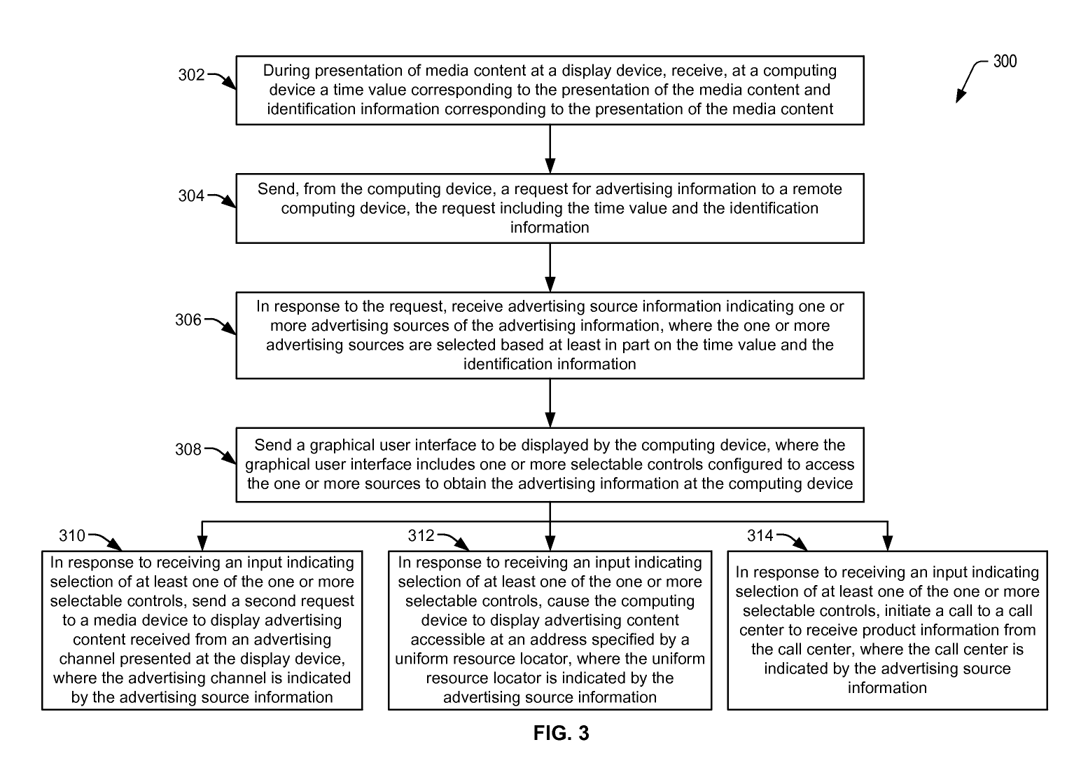

Referring to FIG. 3, a flowchart diagram illustrating a second embodiment of a method 300 to provide implicit advertising associated with presentation of media content is shown. In a particular embodiment, the method 300 may be performed by the computing device 130 of FIG. 1.

At 302, the method 300 includes, during presentation of media content at a display device, receiving, at a computing device, a time value corresponding to the presentation of the media content and identification information corresponding to the presentation of the media content. For example, during presentation of media content at the display device 150 of FIG. 1, the computing device 130 may receive the time value and identification information 148 corresponding to the presentation of media content from the media device 140.

At 304, the method 300 includes sending, from the computing device, a request for advertising information to a remote computing device. The request may include the time value and the identification information. For example, the computing device 130 of FIG. 1 may send the request 158 for advertising information to the computing system 160. The request 158 may include the time value and the identification information 148.

At 306, the method 300 includes, in response to the request, receiving advertising source information indicating one or more advertising sources of the advertising information. For example, in response to the request 158, the computing device 130 of FIG. 1 may receive the advertising source information 168 indicating one or more advertising sources of the advertising information. The one or more advertising sources may be selected based at least in part on the time value and the identification information.

At 308, the method 300 includes sending a graphical user interface to be displayed by the computing device. The graphical user interface may include one or more selectable controls configured to access the one or more sources to obtain the advertising information at the computing device. For example, the computing device 130 of FIG. 1 may send the graphical user interface 110 to be displayed by the computing device at the display device 102. The graphical user interface 110 may include one the selectable controls 104-108 configured to access the one or more sources to obtain advertising information at the computing device 130.

At 310, the method 300 includes, in response to receiving an input indicating selection of at least one of the one or more selectable controls, sending a second request to a media device to display advertising content received from an advertising channel presented at the display device. The advertising channel may be indicated by the advertising source information. For example, in response to receiving an input indicating selection of the selectable control 108 of FIG. 1, the computing device 130 may send a request to the media device 140 to display advertising content received from an advertising channel presented at the display device 150.

At 312, the method 300 includes, in response to receiving an input indicating selection of at least one of the one or more selectable controls, causing the computing device to display advertising content accessible at an address specified by a uniform resource locator. The uniform resource locator may be indicated by the advertising source information. For example, in response to receiving an input indicating selection of the selectable control 104 of FIG. 1, the computing device 130 may cause the display device 102 to display advertising content accessible at an address specified by a uniform resource locator. The uniform resource locator may be indicated by the advertising source information 168.

At 314, the method 300 includes, in response to receiving an input indicating selection of at least one of the one or more selectable controls, initiating a call to a call center to receive product information from the call center. The call center may be indicated by the advertising source information. For example, in response to receiving an input indicating selection of the selectable control 106 of FIG. 1, the computing device 130 of FIG. 1 may initiate a call to the call center 180 to receive product information from the call center 180. The call center 180 may be indicated by the advertising source information 168.

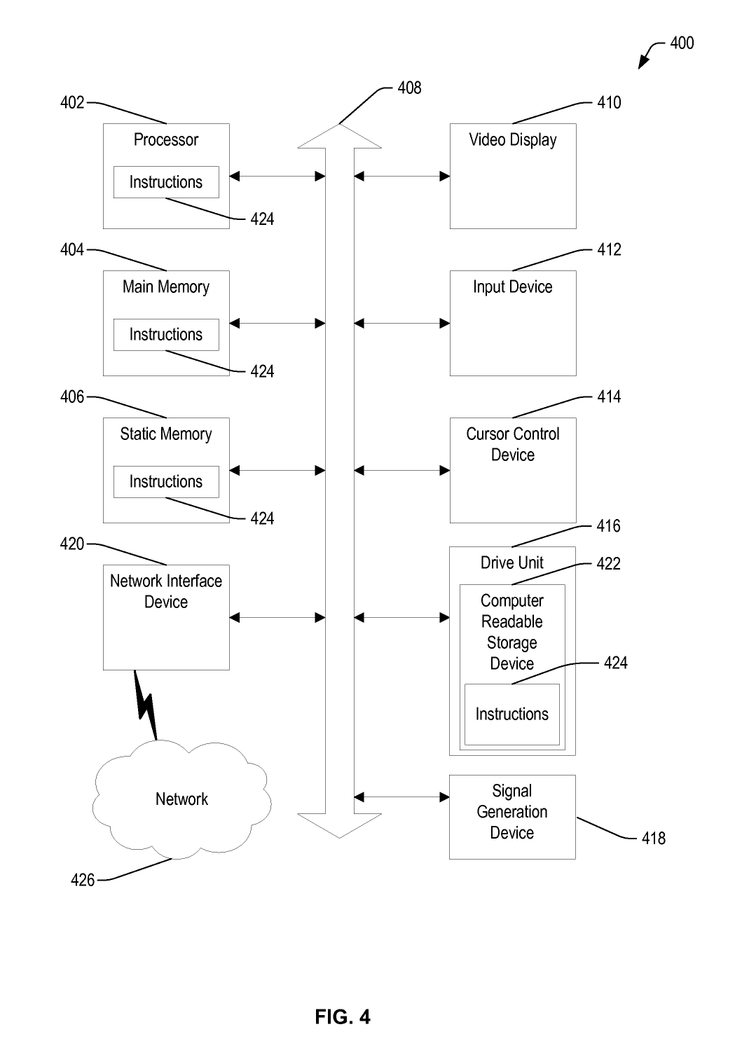

Referring to FIG. 4, an illustrative embodiment of a general computer system is shown and is designated 400. The computer system 400 may include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. For example, the computer system 400 may include, be included within, or correspond to one or more of the components of the system 100, the computing device 130, the display device 102, the media device 140, the display device 150, the computing system 160, the database 190, the call center 180, the content library 170, or a combination thereof described with reference to FIG. 1.

In a networked deployment, the computer system 400 may operate in the capacity of a server or as a client user computer in a server-client user network environment, or as a peer computer system in a peer-to-peer (or distributed) network environment. The computer system 400 may also be implemented as or incorporated into various devices, such as a personal computer (PC), a tablet PC, a STB, a personal digital assistant (PDA), a customer premises equipment device, an endpoint device, a mobile device, a palmtop computer, a laptop computer, a desktop computer, a communications device, a wireless telephone, a web appliance, or any other machine capable of executing a set of instructions (sequential or otherwise) that specify actions to be taken by that machine. In a particular embodiment, the computer system 400 may be implemented using electronic devices that provide video, audio, or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be the processor 132 of FIG. 1, the processor 142 of FIG. 1, the processor 162 of FIG. 1, the processor 182 of FIG. 1, or a combination thereof. Moreover, the computer system 400 may include a main memory 404 and a static memory 406, which can communicate with each other via a bus 408. For example, the main memory 404 may be the memory 134 of FIG. 1, the memory 144 of FIG. 1, the memory 164 of FIG. 1, the memory 184 of FIG. 1, or a combination thereof. As shown, the computer system 400 may further include a video display unit 410, such as a liquid crystal display (LCD), a flat panel display, a solid state display, or a lamp assembly of a projection system. Additionally, the computer system 400 may include an input device 412, such as a keyboard, and a cursor control device 414, such as a mouse. The computer system 400 may also include a drive unit 416, a signal generation device 418, such as a speaker or remote control, and a network interface device 420. Some computer systems 400 may not include an input device (e.g., a server may not include an input device).

In a particular embodiment, as depicted in FIG. 4, the drive unit 416 may include a computer-readable non-transitory storage device 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable non-transitory storage media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a tangible computer-readable storage device 422 that stores the instructions 424 or receives, stores, and executes the instructions 424, so that a device connected to a network 426 may communicate voice, video or data over the network 426. For example, the device may include or be included within one or more of the components of the computing device 130, the media device 140, the computing system 160, the call center 180, or a combination thereof described with reference to FIG. 1. While the tangible computer-readable storage device 422 is shown to be a single device, the tangible computer-readable storage device 422 may include a single medium or multiple media, such as a centralized or distributed database, and/or associated caches and servers that store one or more sets of instructions. The tangible computer-readable storage device 422 may include any tangible medium that is capable of storing a set of instructions for execution by a processor or that cause a computer system to perform any one or more of the methods or operations disclosed herein.

In a particular non-limiting, exemplary embodiment, the tangible computer-readable storage device 422 may include a solid-state memory such as a memory card or other package that houses one or more non-volatile read-only memories. Further, the tangible computer-readable storage device 422 may be a random access memory or other volatile re-writable memory. Additionally, the tangible computer-readable storage device 422 may include a magneto-optical or optical medium, such as a disk or tapes or other storage device. Accordingly, the disclosure is considered to include any one or more of a tangible computer-readable storage device and other equivalents and successor media, in which data or instructions may be stored.

Although the present specification describes components and functions that may be implemented in particular embodiments with reference to particular standards and protocols, the disclosed embodiments are not limited to such standards and protocols. For example, standards and protocols for communication include real-time transport protocol (RTP), transmission control protocol (TCP)/internet protocol (IP), user datagram protocol (UDP)/internet protocol (IP), code division multiple access (CDMA), time division multiple access (TDMA), frequency division multiple access (FDMA), orthogonal frequency division multiple access (OFDMA), single-carrier frequency division multiple access (SC-FDMA), a global system for mobile communications (GSM), enhanced data rates for GSM evolution (EDGE), evolved EDGE, Universal Mobile Telecommunications System (UMTS), Worldwide Interoperability for Microwave Access (Wi-Max), general packet radio service (GPRS), 3rd generation partnership project (3GPP), 3GPP2, 4th generation (4G), long term evolution (LTE), 4G-LTE, high speed packet access (HSPA), HSPA+, Institute of Electrical and Electronics Engineers (IEEE) 802.11x, or a combination thereof. Such standards and protocols are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method comprising:
receiving, at a computing device during presentation of media content at a display device, a time value corresponding to the presentation of the media content and identification information corresponding to an item identified by a marker in the presentation of the media content;
sending, from the computing device, a request for advertising information corresponding to the item identified by the marker to a remote computing device, the request including the time value and the identification information; and
in response to the request, receiving advertising source information indicating an advertising source of the advertising information corresponding to the item.

2. The method of claim 1, wherein the request includes criteria based on user input that identifies the item.

3. The method of claim 1, wherein the remote computing device is associated with a media distribution system.

4. The method of claim 1, wherein the identification information includes a title associated with the media content, a channel identifier associated with the media content during the presentation, or both.

5. The method of claim 1, further comprising sending a graphical user interface to a second display device associated with the computing device, wherein the graphical user interface includes a selectable control.

6. The method of claim 5, further comprising, in response to receiving an input indicating selection of the selectable control, sending a second request to a media device coupled to the display device to display advertising content received by the media device from an advertising channel at the display device, wherein the advertising channel is indicated by the advertising source information.

7. The method of claim 5, further comprising, in response to receiving an input indicating selection of the selectable control, causing the computing device to send to the second display device advertising content accessible at an address specified by a uniform resource locator, wherein the uniform resource locator is indicated by the advertising source information.

8. The method of claim 5, further comprising, in response to receiving an input indicating selection of the selectable control, initiating a call to a call center to receive product information associated with the item from the call center, wherein the call center is indicated by the advertising source information.

9. The method of claim 8, wherein the product information is received from an automated voice response system at the call center, a customer service agent at the call center, or both.

10. The method of claim 1, wherein the display device receives the media content from a media device, and wherein the computing device receives the time value and the identification information from the media device.

11. The method of claim 1, wherein the remote computing device locates an entry of an electronic program guide based on the time value and the identification information, and selects the advertising source information based on the entry.

12. The method of claim 11, wherein the entry includes a uniform resource locator address that identifies a particular advertising source from which the advertising information can be retrieved.

13. The method of claim 1, wherein the request includes criteria based on user input that identifies the item, and wherein the user input comprises voice input.

14. A computing device comprising:
a processor; and
a memory accessible to the processor, the memory storing instructions that, when executed by the processor, cause the processor to perform operations comprising:
during presentation of media content at a display device, receiving a time value corresponding to the presentation of the media content and identification information corresponding to an item identified by a marker in the presentation of the media content;
sending a request for advertising information corresponding to the item identified by the marker to a remote computing device, the request including the time value and the identification information; and
in response to the request, receiving advertising source information indicating an advertising source corresponding to the item.

15. The computing device of claim 14, further comprising a second display device, wherein the operations further comprise sending a graphical user interface to the second display device, and wherein the graphical user interface includes a selectable control.

16. The computing device of claim 15, wherein the operations further comprise, in response to receiving an input indicating selection of the selectable control, causing the computing device to display advertising content accessible at an address specified by a uniform resource locator to the second display device, wherein the uniform resource locator is indicated by the advertising source information.

17. The computing device of claim 14, further comprising a second display device, and wherein the operations further comprise:
storing the advertising source information at the memory; and
after the presentation of media content at the display device, causing a selectable identifier to be sent to the second display device, wherein the selectable identifier enables the processor to access content from the advertising source based on the advertising source information stored at the memory.

18. The computing device of claim 17, wherein the selectable identifier is a bookmark.

19. A computer readable storage device storing instructions that, when executed by a processor, cause the processor to perform operations comprising:
during presentation of media content at a display device, receiving a time value corresponding to the presentation of the media content and identification information corresponding to an item identified by a marker in the presentation of the media content;
sending a request for advertising information corresponding to the item identified by the marker to a remote computing device, the request including the time value and the identification information; and
in response to the request, receiving advertising source information indicating an advertising source of the advertising information corresponding to the item.

20. The computer readable storage device of claim 19, wherein the operations further comprise sending a graphical user interface to a second display device coupled to the processor, wherein the graphical user interface includes a selectable control.
